(19) United States
(12) Patent Application Publication
(10) Pub. No.: US 2008/0077419 A1
(43) Pub. Date: Mar. 27, 2008

(54) System And Method For Training Employees Of An Organization To Align Their Job Activities To Achieving The Organization's Strategic Objectives

(76) Inventors: Pamela M. Santiago, Orlando, FL (US); Maria L. Rasmy, Orlando, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/535,795

(22) Filed: Sep. 27, 2006

(51) Int. Cl. G06Q 10/00

(52) U.S. Cl. 705/1

(57) ABSTRACT

A method of training relating to an organization's business includes the steps of demonstrating a strategy map of various levels of an organization's objectives and showing a relationship between workforce activities and the organization's objectives. A system for training relating to an organization's business includes a strategy map of various levels of an organization's objectives and a plurality of cards for showing a relationship between workforce activities and the organization's objectives.

### COPYRIGHT NOTICE

A portion of the disclosure of this patent document contains material which is subject to copyright protection. The copyright owner has no objection to the reproduction by anyone of the patent document or the patent disclosure in exactly the form it appears in the Patent and Trademark Office patent file or records, but otherwise reserves all copyrights whatsoever.

### TECHNICAL FIELD

The present invention relates to training methods. More specifically, the invention relates to a method for training employees of an organization to understand a strategy map and align their job activities to achieve the organization's objectives reflected in the strategy map.

### BACKGROUND ART

Various management techniques have been developed for use by managers of organizations to improve organization operations. One such technique, know as the balanced scorecard concept, has become increasingly popular among corporations, organizations, and government agencies. The balanced scorecard concept provides a technique for implementing strategies by integrating a measurement system with a management system. One of the key features used to implement the balanced scorecard concept is a strategy map.

A strategy map typically includes a framework that relates business objectives to an overall strategy of an organization. A strategy map may include different levels, or perspectives, of business objectives and may group the objectives into themes that create a cause and effect relationship according to different perspectives. For example, a typical strategy map may include four hierarchically arranged, interrelated perspectives: a financial perspective, a customer perspective, an internal business processes perspective, and a learning and growth perspective.

Although tools such as strategy maps may be useful for improving an organization's operations, it may be difficult for workers, such as employees of the organization, to understand the strategy map in relation to their respective jobs. Lacking a good understanding of the strategy map, employees may not be able to act effectively to achieve the business objectives represented on the map. Accordingly, there is a need in the art for training employees to understand a strategy map so they can align their job activities to achieve the organization's objectives reflected in the strategy map.

### SUMMARY OF THE INVENTION

Broadly speaking, the invention relates to a method and system for training employees of an organization to understand a strategy map and align their job activities to achieve the organization's objectives reflected in the strategy map.

In an embodiment, the invention includes a method of training relating to an organization's business. The method includes the steps of demonstrating a strategy map of various levels of an organization's objectives. The method also includes showing a relationship between workforce activities and the organization's objectives.

In another embodiment, the invention includes a system for training relating to an organization's business. The system includes a strategy map of various levels of an organization's objectives and a plurality of cards for showing a relationship between workforce activities and the organization's objectives.

### BRIEF DESCRIPTION OF THE DRAWINGS

A more particular description of the invention briefly described above may be rendered by reference to specific embodiments thereof that are illustrated in the appended drawings. Understanding that these drawings depict only typical embodiments of the invention and are not therefore to be considered to be limiting of its scope, the invention may be described and explained with additional specificity and detail through the use of the accompanying drawings in which:

FIG. 1 shows an example strategy map for an organization.

FIG. 2 shows a medium, for example, a training exercise card, for promoting understanding of cause and effect relationships between selected objectives of a strategy map.

FIG. 3 shows an example training exercise card for promoting understanding the relationship between selected workplace scenario activities and objectives of the strategy map.

FIG. 4 shows an example training exercise card for promoting understanding, from selected perspectives, of the cause and effect relationships between objectives as drivers and outcomes.

FIG. 5 shows an example training exercise card for promoting understanding of perspectives of a strategy map, and progressive achievement of objectives within a selected perspective.

It should be understood that for reasons of ease of understanding, the ordering and relationships of the blocks of the illustrated charts could be rearranged by one skilled in the art. While the present invention may be described with reference to the details of the embodiments of the invention shown in the drawings, these details are not intended to limit the scope of the invention.

### DETAILED DESCRIPTION

The inventors have recognized that implementation of a balanced scorecard management methodology, and more specifically, a strategy map corresponding to the methodology, may be difficult to achieve due to a lack of adequate understanding of the strategy map. When employees of an organization cannot understand a strategy map, it may be difficult for them to relate their day to day job activities to the objectives of the strategy map and to modify their activities accordingly. Consequently, the strategic goals of an organization as represented in the strategy map may not be realized. To improve implementation of a balanced scorecard methodology incorporating a strategy map, the inventors have developed an innovative training method for teaching employees to understand the strategy map. By teaching an employee to understand the strategy map, employees are in a better position to modify and align their activities to the business objectives expressed in the map, thereby increasing the effectiveness of implementing a balanced scorecard methodology for the organization.

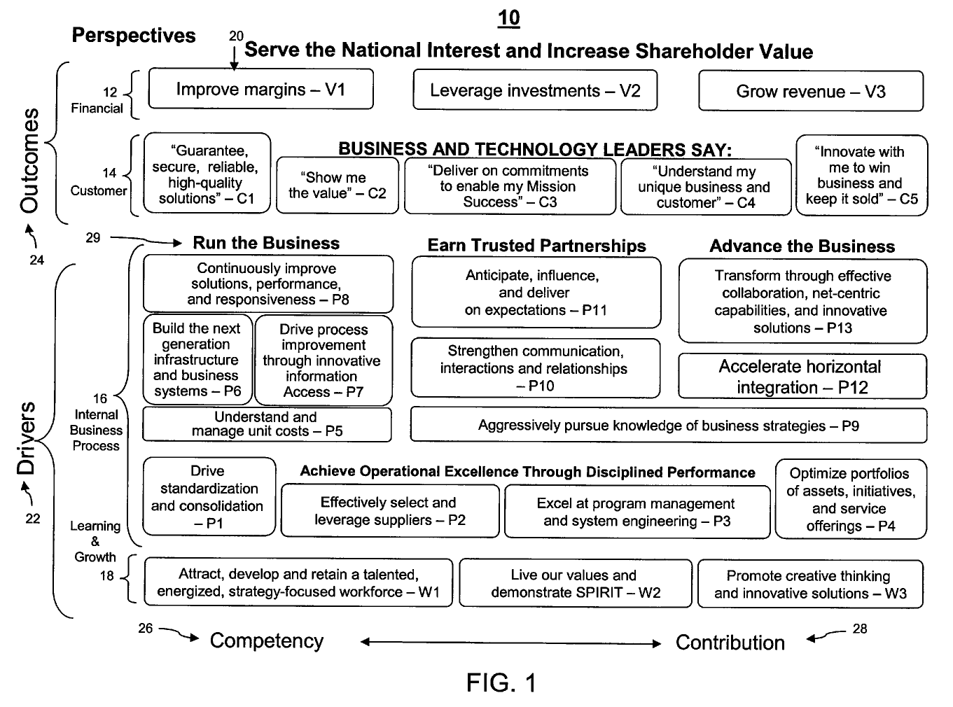

A method of training relating to an organization's business may include the step of demonstrating a strategy map showing various tiered levels (perspectives) of an organization's objectives. FIG. 1 shows an example strategy map 10 that may be used in such a demonstration. Strategy map 10 uses different levels, or perspectives, to describe a cause and effect relationship between strategic objectives 20. For example, the strategy map 10 may include four different perspectives: a financial perspective 12, a customer perspective 14, an internal business process perspective 16, and a learning and growth perspective 18.

Each perspective may include one or more strategic objectives 20 related to the perspective of which it is a member. The objectives 20 may be arranged, such as in a vertical direction, in a cause and effect relationship representing drivers 22 and outcomes 24. According to this arrangement, achievement of selected objectives supports achievement of related (higher tiered/higher level) objectives. Driver objectives may represent what an organization does to achieve its strategic goals, and outcome objectives may represent what an organization delivers to achieve its strategic goals. The objectives 20 may also be arranged, such as in a horizontal direction, from left to right on the strategy map 10 wherein the arrangement of objectives depicts progression from a lesser degree of performance (e.g., competence) to a greater degree of performance (e.g., contribution). For example, the arrangement may proceed from objectives related to competency 26, such as providing competent service in the customer perspective 14, to objectives related to contribution 28, such as being a reliable contributor to the customer in the customer perspective 14. In addition, the objectives 20 may be grouped within perspectives according to one or more themes 29.

Table 1 below lists example objectives that may be used to demonstrate a strategy map, such as strategy map 10 of FIG. 1. Table 1 shows example perspectives, example objectives that may be included in each perspective, and example theme membership of the objective. The alphanumeric indicators shown in the Objectives column of Table 1 correspond to the alphanumeric indicators and associated objectives shown in FIG. 1.

TABLE 1

| Perspective (Levels) | Objectives | Themes |
|---|---|---|
| Financial | V1-V3 | Serve the National Interest |
| | | and Increase Shareholder |
| | | Value |
| Customer | C1-C5 | Business and Technical |
| | | Leaders Say: |
| Business Process | P1-P13 | Run the Business, Earn |
| | | Trusted Partnerships, |
| | | Advance the Business, |
| | | Achieve Operational |
| | | Excellence through |
| | | Disciplined Performance |
| Learning and Growth | W1-W3 | n/a |

After demonstrating a strategy map of an organization, such as by describing the elements of the strategy map and their relationships, the method of training may include the step of showing a relationship between job activities and the organization's objectives represented on the strategy map. This step may include showing that selected objectives can become drivers for achieving other selected objectives representing desired outcomes. In an embodiment of the invention, this step may be accomplished using an exercise card that includes training exercises.

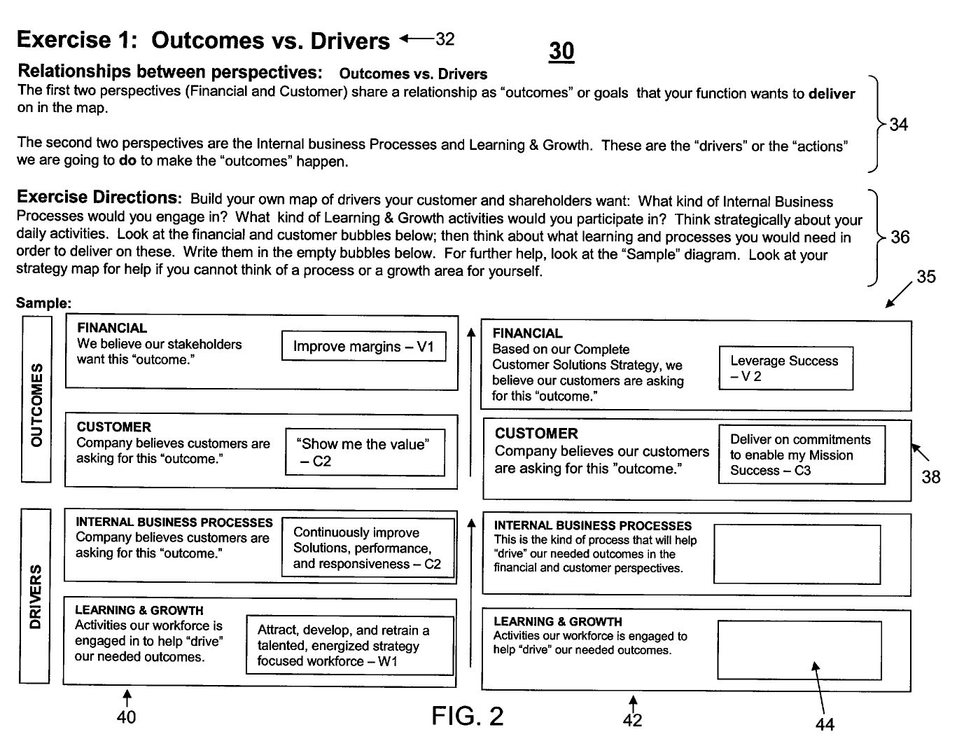

FIG. 2 shows an example training exercise card 30 useful for showing a relationship between objectives representing drivers and objectives representing outcomes. The card 30 may include a title 32 describing the training exercise and description section 34 describing the relationships between drivers and outcomes. The card 30 may also include an exercise section 35 that may include exercise instructions 36 and a visual aid 38 for performing the exercise. The exercise instructions 36 may include questions to pose to trainees, such as employees of an organization being trained according to the method, for increasing their understanding of relationships between objectives that may be drivers and those that may be outcomes. The exercise instructions 36 may also include directions for trainees to determine objectives for drivers based on given outcomes. In conjunction with the exercise instructions 36, the visual aid 38 may include a first strategy map portion 40 showing objectives for respective drivers and outcomes. The visual aid 38 may also include a second strategy map portion 42 showing outcome objectives and one or more blank spaces 44 for driver objectives to be filled in by a trainee. By having trainees consider appropriate driver objectives to be inserted in the blank spaces 44, it is believed that their understanding of relationships between drivers and outcomes may be increased.

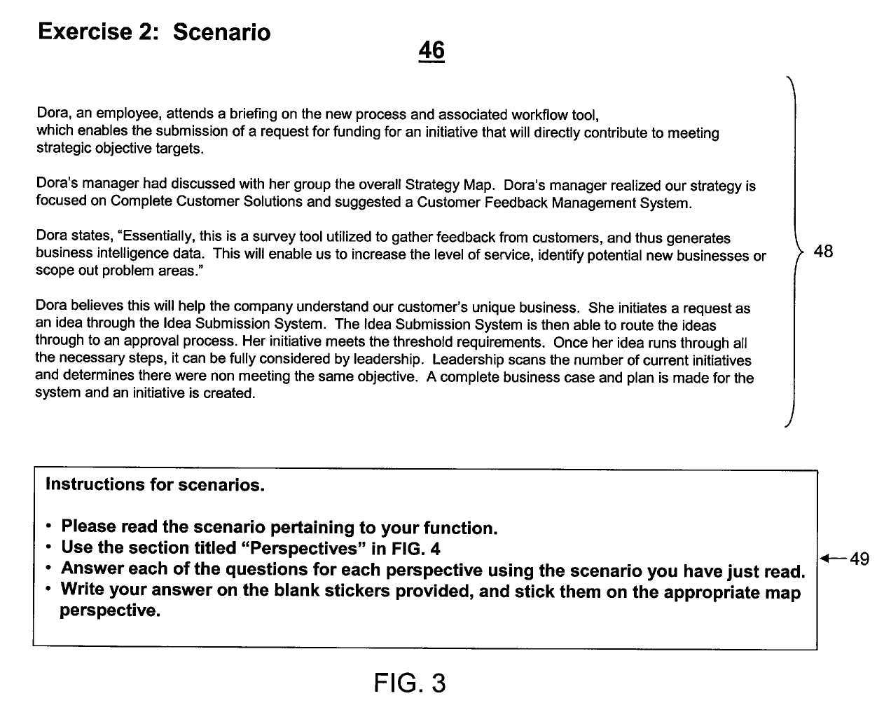

In another embodiment, the step of showing a relationship between workforce activities and the organization's objectives may include showing how to relate scenarios of work activities to respective drivers and outcomes. In an aspect of the invention, this step may be accomplished using an exercise card that includes training exercises. FIG. 3 shows an example training exercise card 46 useful for showing how to relate work environment scenarios to respective drivers and outcomes. The training exercise card 46 may include a narrative 48 describing work activities of a worker, wherein the activities described in the narrative 48 are capable of being identified as relating to or identified with respective objectives in one or more perspectives of a strategy map. In an example embodiment, the narrative 48 may include a description of an employee attending a meeting to learn about a tool to submit a request for funding an initiative for meeting strategic goals. Such a work activity may be characterized as relating to a learning and growth objective. The narrative 48 may also include a description of need to develop a customer feedback management system to gather feedback from customers to generate business intelligence. The work activity necessary for developing such a system may also be characterized as relating to a learning and growth objective. A system resulting from this work activity may be characterized as relating to an internal business process objective. The narrative 48 may further include a description of how the proposed system may help a trainee understand a customer's unique business, thereby relating to a customer objective.

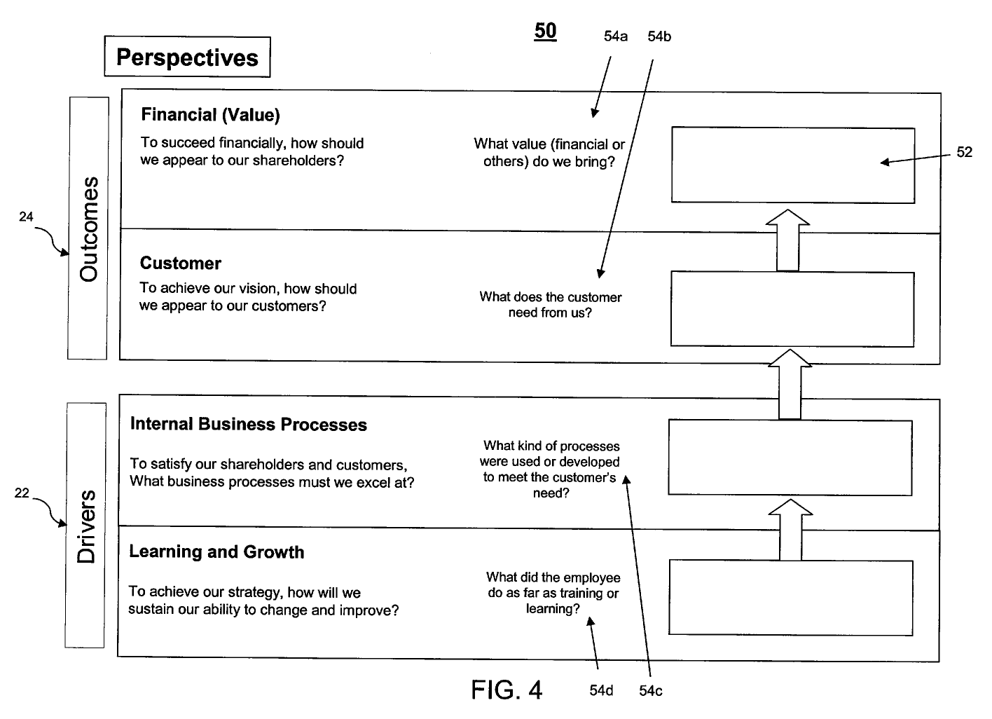

In addition to the narrative 48, the card 46 may also include exercise instructions 49 for directing a trainee to read the narrative 48 and then characterize work activities described in the narrative 48 as relating to a respective perspective of a strategy map. The card 46 may be used in conjunction with a strategy map 50, as shown in FIG. 4, that includes blank spaces 52 associated with each perspective. The trainee may be instructed to fill in the blank spaces 52 with work activities described in the narrative 48 according to perspectives that the trainee believes the work activities relate to. The strategy map 50 may also include prompting questions 54a . . . 54d associated with each perspective to assist a trainee in categorizing types of work activities described in the narrative 48 according to perspectives to which they relate. By associating work activities described in the narrative 48 with appropriate perspectives, it is believed that a trainee's understanding of relationships between workforce activities and an organization's objectives represented on the strategy map may be improved. In addition, by associating workforce environment scenarios to respective drivers 22 and outcomes 24, an understanding of relationships between drivers 22 and outcomes 24 may be increased through a cause and effect relationship.

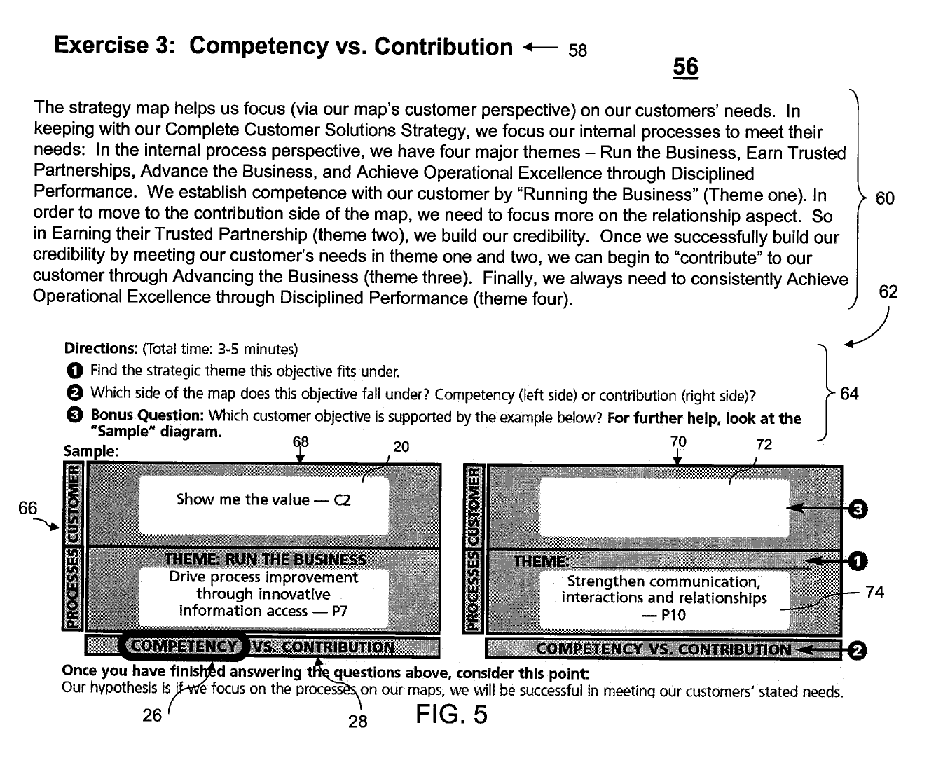

In another embodiment of the invention, the step of showing a relationship between workforce activities and the organization's objectives may include identifying process themes to advance from providing competent service to contributing to the customer. In an aspect of the invention, this step may be accomplished using an exercise card that includes training exercises. FIG. 5 shows an example training exercise card 56 useful for identifying process themes. The card 56 may include a title 58 describing the training exercise and a description section 60 describing process themes, such as themes associated with an internal business process perspective. The card 56 may also include an exercise section 62 that may include exercise instructions 64 and a visual aid 66 for performing the exercise. For example, the exercise instructions 64 may include questions to pose to trainees to enable them to identify process themes. The exercise instructions 64 may also include directions for trainees to find strategic themes on a strategy map and to determine whether the objectives belong on a competency side of the strategy map or a contribution side of the map. The exercise instructions 64 may also include directions for trainees to determine a customer objective corresponding to a related business process objective.

In conjunction with the instructions 64, the visual aid 66 may include a first strategy map portion 68 showing objectives for a business process perspective and objectives for a customer perspective related to the business process perspective. First strategy map portion 68 may also indicate whether the objectives are related to competency 26 or contribution 28. The visual aid 66 may also include a second strategy map portion 70 showing example business process objectives and having blank spaces 72, 74 for an appropriate customer objective and an appropriate theme, respectively, to be filled in by a trainee. By having trainees consider appropriate customer objectives and an appropriate theme to be inserted in the blank spaces 72, 74 and having the trainee determine whether the objectives belong on a competency side or contribution side, it is believed that their understanding of process themes to advance from providing competent service to contributing to the customer may be increased.

As a system, an embodiment may include a strategy map, such as strategy map 10 depicted in FIG. 1, of various levels of an organization's objectives. The system may also include a plurality of cards, such as exercise card 30 of FIG. 2, exercise card 46 of FIG. 3, and exercise card 56 of FIG. 5, for showing a relationship between workforce activities and the organization's objectives. For example, exercise card 30 may include indicia such as description section 34 and exercise section 35 for showing how objectives are arranged in a cause and effect relationship representing drivers and outcomes. Exercise card 46 may include indicia such as narrative 48 and exercise instructions 49 for showing how to relate scenarios of work activities to respective drivers and outcomes. Exercise card 56 may include indicia such as description section 60 and exercise section 62 for showing how arrangement of objectives depicts progression from a lesser or competence performance status to a greater or contributory performance status.

It should be understood that the examples and embodiments described herein are for illustrative purposes only, and that modifications thereto or changes in light thereof, as may be suggested to persons skilled in the art are to be included within the spirit and purview of the claims.

What is claimed is:

1. A method of training relating to an organization's business, the method comprising the steps of:
demonstrating a strategy map of various levels of an organization's objectives; and
showing a relationship between workforce activities and the organization's objectives.

2. The method of claim 1, wherein the objectives are arranged in a cause and effect relationship representing drivers and outcomes.

3. The method of claim 2, wherein, according to said arrangement, achievement of selected objectives supports achievement of related objectives.

4. The method of claim 3, wherein selected objectives relate to learning and growth as a selected level.

5. The method of claim 4, wherein other selected objectives relate to an internal business process as another selected level.

6. The method of claim 5, wherein still other selected objectives relate to a customer as still another selected level.

7. The method of claim 6, wherein further selected objectives relate to financial as a further selected level.

8. The method of claim 3, wherein the objectives of at least one level are grouped according to a selected theme.

9. The method of claim 2, further comprising the step of showing how to relate scenarios of work activities to respective drivers and outcomes.

10. The method of claim 2, wherein the arrangement of objectives depicts progression from a lesser degree of performance to a greater degree of performance.

11. A system for training relating to an organization's business comprising:
a strategy map of various levels of an organization's objectives;
a plurality of cards for showing a relationship between workforce activities and the organization's objectives.

12. The system of claim 11, wherein at least one of the plurality of cards comprises indicia for showing how objectives are arranged in a cause and effect relationship representing drivers and outcomes.

13. The system of claim 11, wherein at least one of the plurality of cards comprises indicia for showing how to relate scenarios of work activities to respective drivers and outcomes.

14. The system of claim 11, wherein at least one of the plurality of cards comprises indicia for showing how arrangement of objectives depicts progression from a lesser degree of performance to a greater degree of performance.
